(19) United States
(12) Patent Application Publication
(10) Pub. No.: US 2011/0149578 A1
(43) Pub. Date: Jun. 23, 2011

(54) LIGHT-EMITTING DEVICE

(76) Inventors: Heiji Niiyama, Tokyo (JP); Tsubasa Niiyama, Tokyo (JP)

(21) Appl. No.: 13/058,522

(22) PCT Filed: Aug. 11, 2009
(86) PCT No.: PCT/JP2009/064189

§ 371 Date: Feb. 10, 2011

(30) Foreign Application Priority Data
Aug. 12, 2008 (JP) 2008-229048
Jan. 19, 2009 (JP) 2009-008916

(51) Int. Cl. F21V 29/00

(52) U.S. Cl. 362/294

(57) ABSTRACT

Disclosed is a heat-resistant light-emitting device wherein luminance is increased by increasing the light emission area. A light-emitting device 1 comprises: a plate-like heat dissipation member 2; a light-emitting body 3 emitting linear or surface light, which is mounted on the heat dissipation member 2 and has a substrate 31 and a semiconductor laminate 32 formed on substrate 31; a fluorescent lens 4 covering the light-emitting body 3 on the heat dissipation member 2; and a light-emitting-body-side vacuum heat insulation layer 5 formed between fluorescent lens 4 and the light-emitting body 3. The light-emitting device 1 secures heat dissipation performance, while increasing the light emission area.

### TECHNICAL FIELD

The present invention relates to a light-emitting device which can be used as an alternative to a lighting fixture such as an incandescent lamp, a mercury lamp, a fluorescent lamp and the like.

### BACKGROUND ART

Lighting formed from electroluminescence (EL) panels and those equipped with point source light-emitting diodes (LEDs) and light guide plates are conventionally-known planar light-emitting devices. Patent document 1 proposes a point source LED improving the light resistance of phosphor, comprising an LED element housed inside a cup on top of a mount lead, an external cap covering the upper part of a blanket, and a phosphor layer applied to the inside of the external cap, wherein the inside of the cap is a vacuum or an inert gas.

In addition, Patent document 2 proposes a point source LED light-emitting device with a heat insulation layer formed in a reduced-pressure atmosphere, comprising a semiconductor light-emitting element formed of a blue LED element, a heat insulation layer covering the main light-emitting area side of the semiconductor light-emitting element, a phosphor layer disposed on the upper side of the heat insulation layer, a housing containing the semiconductor light-emitting element, a submount on top of which electrodes are arranged, and on which the semiconductor light-emitting element is mounted, two lead frames each electrically connected by the submount and a bonding wire, and a heat dissipation member.

### PRIOR ART DOCUMENTS

### Patent Documents

Patent document 1: JP2004-A-352928
Patent document 2: JP2007-A-66939

### SUMMARY OF THE INVENTION

### Problems to be Solved by the Invention

However, there is a problem that EL panels have low luminance and a complicated manufacturing process compared to LEDs. In addition, light-emitting devices using point source LEDs are relatively susceptible to heat, making it difficult to realize high luminance with large current.

The present invention takes the above-mentioned circumstances into consideration, and it is an object of the present invention to provide a heat-resistant light-emitting device capable of achieving high luminance by increasing the light emission area.

### Means for Solving the Problems

In order to achieve the above-mentioned objective, the present invention provides a light-emitting device comprising: a plate-like heat dissipation member; a light-emitting body emitting linear or planar light, which is mounted on the heat dissipation member, and which has a substrate, and a semiconductor laminate extending in a predetermined direction and including a first conductivity-type first semiconductor layer, a light-emitting layer, and a second conductivity-type second semiconductor layer; a fluorescent lens covering the light-emitting body on the heat dissipation member, which emits light with a different wavelength from the light of the light-emitting body when excited by the light; a light-emitting-body-side vacuum heat insulation layer formed between the fluorescent lens and the light-emitting body; a diffusion lens covering the outside of fluorescent lens, which diffuses light passing through the fluorescent lens and; a lens-side vacuum heat insulation layer formed between the diffusion lens and the fluorescent lens; wherein the heat dissipation member extends in the same direction as the extending direction of the light-emitting body.

According to this light-emitting device, the semiconductor laminate extends in a predetermined direction, so that a relatively large current can be passed through the semiconductor laminate, and a linear or planar light-emitting body can be allowed to emit light therefrom at an arbitrary luminance. In addition, the semiconductor laminate extends in a predetermined direction, so that the light emission area can be relatively increased, and the light emission state that is approximately uniform can be realized along the extension direction of the semiconductor laminate. Most of the heat generated in the semiconductor laminate is transmitted to the heat dissipation member side, this heat is hardly transmitted to the fluorescent lens side due to heat insulation by the light-emitting-body-side vacuum heat insulation layer, so that deterioration of the fluorescent lens can be inhibited. In addition, the plate-like shape of the heat dissipation member also allows the device to be made slim. Furthermore, since the heat dissipation member extends in the same direction as the extension direction of the light-emitting body, the heat dissipation area of the heat dissipation member can be increased, and heat transmission state that is approximately uniform can be realized along the extension direction of the heat dissipation member, thus the device's heat dissipation performance can be improved.

In the light-emitting device described above, it is preferable that the light-emitting body is mounted on the center part in the width direction of the heat dissipation member.

According to the light-emitting device, heat generated from the light-emitting body is transmitted from the center side to the both end sides in the width direction of the heat dissipation member. Due to this, the heat generation can be efficiently dissipated in comparison with a case that the light-emitting body is mounted on the end parts in the width direction of the heat dissipation member.

In the light-emitting device described above, it is preferable that the light-emitting body is formed of one element extending in the predetermined direction.

According to the light-emitting device, the light-emitting body is formed of one element, so that variation in luminance, chromaticity and the like in the element is not visually recognized different from a case that the light-emitting body is formed of a plurality of elements adjacent to each other.

In the light-emitting device described above, it is preferable that the light-emitting device comprises a diffusion lens covering the outside of the fluorescent lens and diffusing the light which passes through the fluorescent lens, and a lens-side vacuum heat insulation layer formed between the diffusion lens and the fluorescent lens.

According to the light-emitting device, the light which passes through the fluorescent lens is diffused by the diffusion lens, so that the light emission state can be further homogenized. In addition, the lens-side vacuum heat insulation layer is formed, so that heat applied to the diffusion lens from is hardly transmitted to the fluorescent lens, and deterioration of the fluorescent lens due to heat generation factor at the outside of the device can be inhibited.

In the light-emitting device described above, it is preferable that the diffusion lens inhibits external ultraviolet light from penetrating.

According to the light-emitting device, it inhibits external ultraviolet light from passing through the diffusion lens so as to penetrate the fluorescent lens, so that deterioration of the fluorescent lens due to ultraviolet light can be inhibited.

In the light-emitting device described above, it is preferable that the light-emitting device comprises a heat insulating material installed on the outer edge side of the upper surface of the heat dissipation member, and the diffusion lens is installed on the heat dissipation member via the heat insulating material.

According to the light-emitting device, the heat generated in the semiconductor laminate is hardly transmitted to the diffusion lens side, so that deterioration of the diffusion lens can be inhibited.

In the light-emitting device described above, it is preferable that the diffusion lens is welded on the heat insulating material.

According to the light-emitting device, the diffusion lens and the heat insulating material can be joined together without any interstices, and in case that the inside of the diffusion lens is vacuated, airtightness thereof can be adequately ensured.

In the light-emitting device described above, it is preferable that the fluorescent lens is installed on the heat dissipation member via the heat insulating material.

According to the light-emitting device, the heat generated in the semiconductor laminate is hardly transmitted to the fluorescent lens side, so that deterioration of the fluorescent lens can be inhibited, and the color of light emitted by the device can be inhibited from changing over time.

In the light-emitting device described above, it is preferable that the fluorescent lens and the diffusion lens are made from glass.

According to the light-emitting device, the fluorescent lens and diffusion lens have enhanced resistance to heat, weather and the like in comparison with the lenses formed from resin.

In the light-emitting device described above, the light-emitting body does not have to be sealed with a sealing material.

According to the light-emitting device, the light emitted from this light-emitting device does not change over time due to the deterioration of the sealing material. In addition, the process of sealing the light-emitting body can be omitted at the time of manufacturing the device, so that the manufacturing costs can also be reduced.

### Advantages of the Invention

The light-emitting device of the present invention can cause the light-emitting body to emit either linear or planar light although it adopts a structure of LED, so that the light emission area can be increased and high luminance can be achieved, consequently it can provides a suitable alternative to a lighting fixture such as an incandescent lamp, a mercury lamp, a fluorescent lamp and the like. In addition, it can inhibit deterioration of the fluorescent lens due to heat generated in the semiconductor laminate, so that it can have high heat resistance and is capable of passing a large current through the light-emitting body. Furthermore, the heat dissipation member is formed in a plate-like shape, so that the heat emission area can be increased and the device can be slimmed down.

### BRIEF DESCRIPTION OF THE DRAWINGS

FIG. 1 is an external explanatory view showing a light-emitting device according to a first embodiment of the present invention.

FIG. 2 is a schematic vertical sectional view showing the light-emitting device.

FIG. 3 is a plan view showing the light-emitting device.

FIG. 4 is a schematic vertical sectional view showing a modification of the light-emitting device.

FIG. 5 is a schematic vertical sectional view showing a modification of the light-emitting device.

FIG. 6 is a schematic vertical sectional view showing a light-emitting device according to a second embodiment of the present invention.

FIG. 7 is a plan view schematically showing a semiconductor wafer.

FIG. 8 is a schematic vertical sectional view showing a modification of the light-emitting device.

### EXPLANATION OF REFERENCE NUMERALS

1 Light-emitting device
2 External substrate
2a First electrode
2b Ssecond electrode
3 Light-emitting body
3a First wire
3b Second wire
4 Fluorescent lens
4a Fluorescent layer
4b Diffusion layer
5 Light-emitting-body-side vacuum heat insulation layer
6 Light reflector plate
7 Sealing resin
8 Phosphor
9 Heat insulating material
16 Reflector member
18 Diffusion material
31 Growth substrate
32 Semiconductor laminate
33 n-type semiconductor layer
34 Light-emitting layer
35 p-type semiconductor layer
36 n-side electrode
37 p-side electrode
101 Light-emitting device
102 External substrate
102a First electrode
102b Second electrode
103 Light-emitting body
103a First wire
103b Second wire
104 Fluorescent lens
104a Fluorescent layer
104a Diffusion layer
105 Light-emitting-body-side vacuum heat insulation layer
106 Light reflector plate
107 Sealing resin
108 Phosphor
109 Heat insulating material
115 Lens-side vacuum heat insulation layer
116 Reflector member
118 Diffusion material
121 Communicating hole
122 Blocking member
131 Growth substrate
132 Semiconductor laminate
133 n-type semiconductor layer
134 Light-emitting layer
135 p-type semiconductor layer
136 n-side electrode
137 p-side electrode

### EMBODIMENT FOR CARRYING OUT THE INVENTION

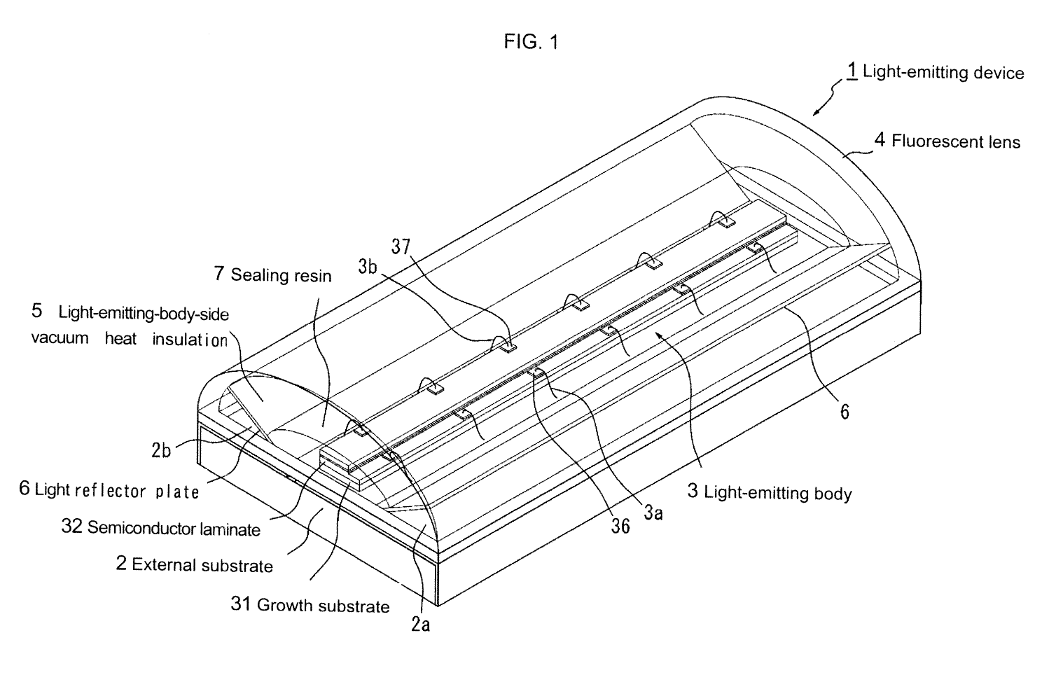

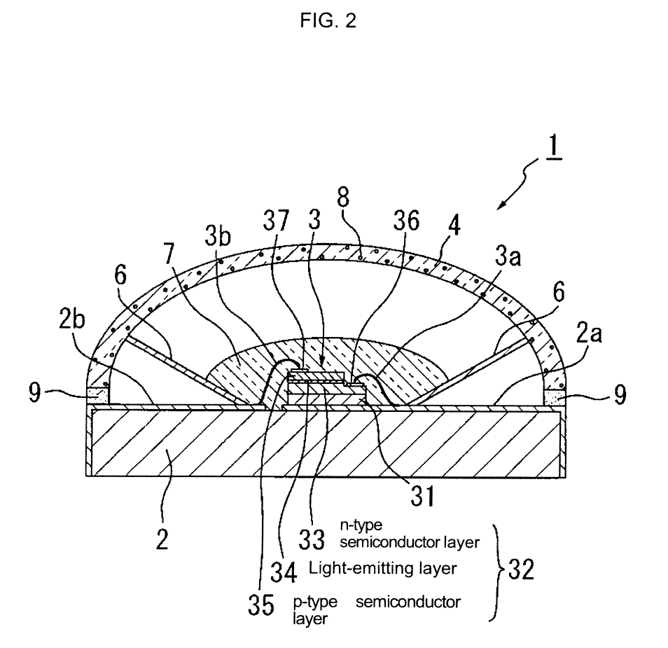

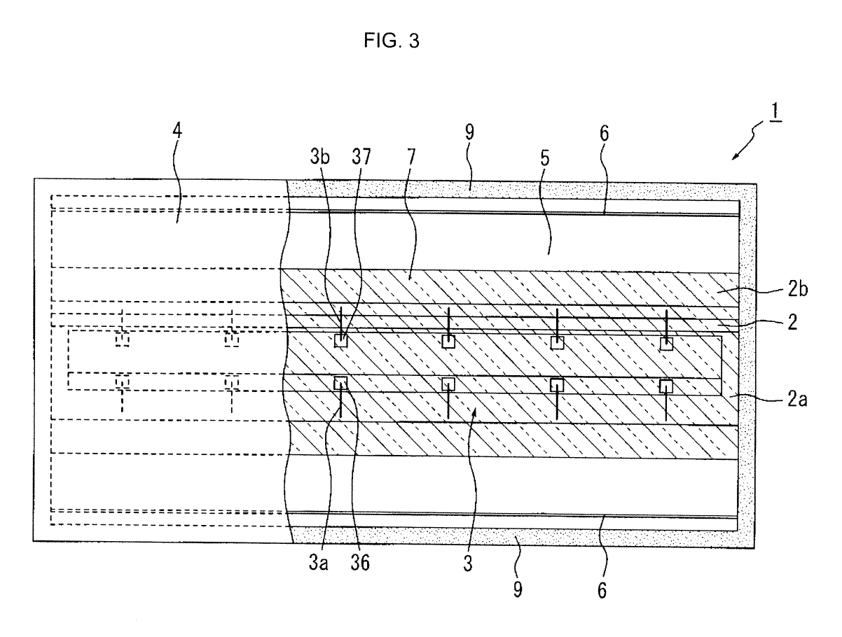

FIG. 1 to FIG. 3 show a first embodiment of the present invention, and FIG. 1 is an external explanatory view showing a light-emitting device, FIG. 2 is a schematic vertical sectional view showing the light-emitting device, and FIG. 3 is a plan view showing the light-emitting device.

As shown in FIG. 1, a light-emitting device 1 includes an external substrate 2 as a plate-like heat dissipation member, a light-emitting body 3 mounted on the external substrate 2, which emits linear light, a fluorescent lens 4 covering the light-emitting body 3 on the external substrate 2, and a light-emitting-body-side vacuum heat insulation layer 5 formed between the fluorescent lens 4 and the light-emitting body 3. In addition, the light-emitting body 3 has a growth substrate 31, and a semiconductor laminate 32 formed on the growth substrate 31 by epitaxial growth. The light-emitting device 1 also includes a light reflector plate 6 on the external substrate 2, which reflects the light emitted from the light-emitting body 3 in a predetermined direction.

The external substrate 2 is, for example, an interposer made of an inorganic material and having excellent heat dissipation properties. In the light-emitting device 1 shown in FIG. 1, the external substrate 2 functions as a heat dissipation member on its own, but it is also possible to connect a heat sink to the external substrate 2. In the embodiment, the external substrate 2 is made of a ceramic such as AIM and, in a planar view, is formed in a rectangular shape extending in a predetermined direction.

As shown in FIG. 3, the light-emitting body 3 extends in the same direction as the external substrate 2 in a planar view, and emits light linearly on the rectangular external substrate 2. Further, the light-emitting body 3 can be formed not only in a linear shape, but also in a planar shape extending along two directions of the longitudinal and lateral directions of the external substrate 2. In the embodiment, the light-emitting body 3 is a face-up type, while the growth substrate 31 of the light-emitting body 3 is made of sapphire, and the semiconductor laminate 32 is made of gallium nitride (GaN) based material. As shown in FIG. 2, the semiconductor laminate 32 has an n-type semiconductor layer 33, a light-emitting layer 34, and a p-type semiconductor layer 35, respectively from the side of the growth substrate 31, and an n-side electrode 36 and a p-side electrode 37 are formed on the n-type semiconductor layer 33 and the p-type semiconductor layer 35 respectively. Further, after partially exposing the n-type semiconductor layer 33 by removing parts of the light-emitting layer 34 and the p-type semiconductor layer 35 by etching, the n-side electrode 36 is formed thereupon. The electrodes 36 and 37 are electrically connected to a first electrode 2a and a second electrode 2b on the external substrate 2 via a first wire 3a and a second wire 3b respectively. In the embodiment, a plurality of the first wires 3a and second wires 3b are installed along the extension direction of the light-emitting body 3 as shown in FIG. 3.

In addition, the light-emitting body 3 emits blue light of which peak wavelength is, for example, 460 nm. In addition, the light-emitting body 3 is sealed with a transparent resin 7 such as epoxy resin or silicon. This transparent resin 7 does not contain any phosphor, so that the light emitted from the light-emitting body 3 passes through it without modification. The transparent resin 7 is preferably a highly heat-resistant resin. Further, it is also possible to seal the light-emitting body 3 with an inorganic material such as glass.

In addition, as shown in FIG. 3, the light-emitting body 3 is mounted on the center part in the width direction of the external substrate 2. Furthermore, the light-emitting body 3 is formed of one LED element extending in the same direction as the extension direction of the external substrate 2. Namely, the light-emitting device 1 is entirely different in morphology from the LED print head in which the light-emitting body is mounted on the end parts in the width direction of the external substrate, and which is formed of a plurality of elements.

As shown in FIG. 2, the fluorescent lens 4 is made of a transparent material such as glass, and contains a phosphor 8. The glass used in the lens 4 preferably has a low melting point. Further, it is also possible to form the fluorescent lens 4 from a transparent material other than glass, such as fiber-reinforced plastics (FRP). When the phosphor 8 is excited by the light emitted from the light-emitting body 3, it emits a light with a different wavelength to that of the light. In the embodiment, the light-emitting body 3 is a yellow phosphor which emits a yellow light when excited by a blue light, and for example, yttrium aluminum garnet (YAG), silicate or the like is used. In addition, the fluorescent lens 4 is installed via a heat-insulating material 9 disposed on the outer edge of the upper surface of external substrate 2. In other words, the heat insulating material 9 is formed so as to enclose the inner side of external substrate 2 in a planar view. By welding the fluorescent lens 4 to the heat insulating material 9, it is possible to keep the fluorescent lens 4 airtight. While the material of the heat insulating material 9 is optional, it is possible to use, for example, phenol resin, epoxy resin, melamine resin or silicone resin. The fluorescent lens 4 has a semi-elliptical shape which extends in the same direction as the extension direction of external substrate 2, and is formed to substantially align with the external substrate 2 in a planar view.

The light-emitting-body-side vacuum heat insulation layer 5 is formed by decompressing a gas, such as air, below atmospheric pressure. Here, the term “vacuum” does not mean a state that matter is completely absent, but a state that the gas is decompressed to the extent that it possesses a thermal insulating action. The internal pressure of light-emitting-body-side vacuum heat insulation layer 5 is preferably not more than 15 Torr, more preferably not more than 1.0 Torn and even more preferably not more than 0.1 Torr. In addition, it is also possible to make the internal pressure of light-emitting-body-side vacuum heat insulation layer 5 not more than 10-5 Torr, or not more than 10-9 Torr.

The light reflector plate 6 is formed of a heat insulating material, and is disposed in a pair on both sides in the width direction of the light-emitting body 3. The material of light reflector plate 6 is optional, but it is possible to use, for example, phenol resin, epoxy resin, melamine resin or silicone resin. As shown in FIG. 2, the light reflector plate 6 divides the space between the external substrate 2 and the fluorescent lens 4. On the surface of the light reflector plate 6, a thin metallic film such as an aluminum film with relatively high reflectivity is preferably formed.

According to the light-emitting device 1 configured as stated above, when the light-emitting body 3 is energized via the first conductor 2a and second conductor 2b of the external substrate 2, blue light is caused to be emitted from the light-emitting body 3, and this blue light then directly or indirectly enters the fluorescent lens 4. Blue light emitted in the direction of the light reflector plate 6 is reflected by the light reflector plate 6 and indirectly enters the fluorescent lens 4. Part of the blue light which enters the fluorescent lens 4 is converted to yellow light by the phosphor 8, and a mixture light of blue light and yellow light is then radiated from the fluorescent lens 4 to the outside. When this occurs, the mixed light is optically controlled by the surface of the fluorescent lens 4 and radiated in a desired direction. This is how white light is radiated from the light-emitting device 1.

In the embodiment, the semiconductor laminate 32 extends in a predetermined direction, so that a relatively large current can be passed through the semiconductor laminate 32 via a plurality of the wires 3a and 3b, and the light-emitting body 3 of a linear shape can be caused to emit light at an arbitrary luminance. This is how the device can achieve high luminance.

Most of the heat generated in the light-emitting body 3 when it emits light is transmitted to the side of the external substrate 2, and this heat is hardly transmitted to the side of the fluorescent lens 4 due to heat insulation by the light-emitting-body-side vacuum heat insulation layer 5, thereby deterioration of the phosphor 8 contained in the fluorescent lens 4 can be inhibited. In addition, since heat is not transmitted from the mounting portion of the light-emitting body 3 towards the fluorescent lens 4, in case that the light-emitting body 3 is used as a lighting fixture for illuminating indoor spaces or objects to be illuminated, the illuminated indoor space or object is not heated or thermally influenced by the light-emitting device 1. Furthermore, the heat generated in the semiconductor laminate 32 is hardly transmitted to the side of the fluorescent lens 4, thereby deterioration of the phosphor 8 contained in the fluorescent lens 4 can be inhibited and the color of light emitted by the device can be inhibited from changing over time. It is therefore possible to exploit the inherently long life of the LED in the light-emitting body 3 without having to consider the deterioration of the phosphor 8.

The heat dissipation member is formed in a plate-like shape, so that the heat emission area can be easily increased, heat dissipation performance can be enhanced, and the device can be slimmed down, consequently it is very useful in practical applications. By installing the light reflector plate 6, the light emitted from the light-emitting body 3 can be effectively extracted.

In addition, according to the embodiment, the heat radiated from the light-emitting body 3 is transmitted from the center side to the both end sides in the width direction of the external substrate 2. Due to this, the heat generation can be efficiently dissipated in comparison with a case that the light-emitting body 3 is mounted on the end parts in the width direction of the external substrate 2. Furthermore, according to the light-emitting device 1, the light-emitting body 3 is formed of one element, so that variation in luminance, chromaticity and the like in the element is not visually recognized different from a case that the light-emitting body 3 is formed of a plurality of elements adjacent to each other.

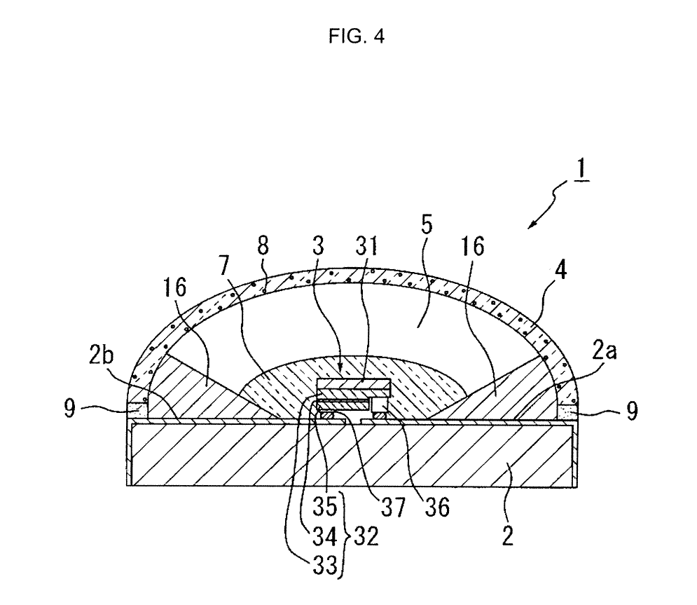

Further, although the light-emitting body 3 shown in the above-described embodiment was the face-up type, the light-emitting body 3 may also be a flip-chip type, for example, as shown in FIG. 4. It is also possible to change the emission wavelength and materials of the light-emitting body 3 as desired. For example, the light-emitting body 3 may also emit ultraviolet light, and the fluorescent lens 4 may contain blue, green and red phosphor excited by the ultraviolet light. In addition, it is also possible to obtain white light without including phosphor by combining a plurality of types of the light-emitting body 3 each having different emission wavelengths. Furthermore, instead of using the growth substrate 31, the substrate of the light-emitting body 3 can also be a support substrate laminated after epitaxial formation.

In addition, a pair of the light reflector plate 6 dividing the space between the fluorescent lens 4 and the external substrate 2 was shown in the above-described embodiment, but it is also perfectly acceptable to install a reflector member 16 having a reflective surface on the external substrate 2, for example, as shown in FIG. 4.

The light-emitting body 3 sealed by the sealing resin 7 was shown in the above-described embodiment, but the light-emitting body 3 is sealed with glass, so that the device can be further improved in heat resistance.

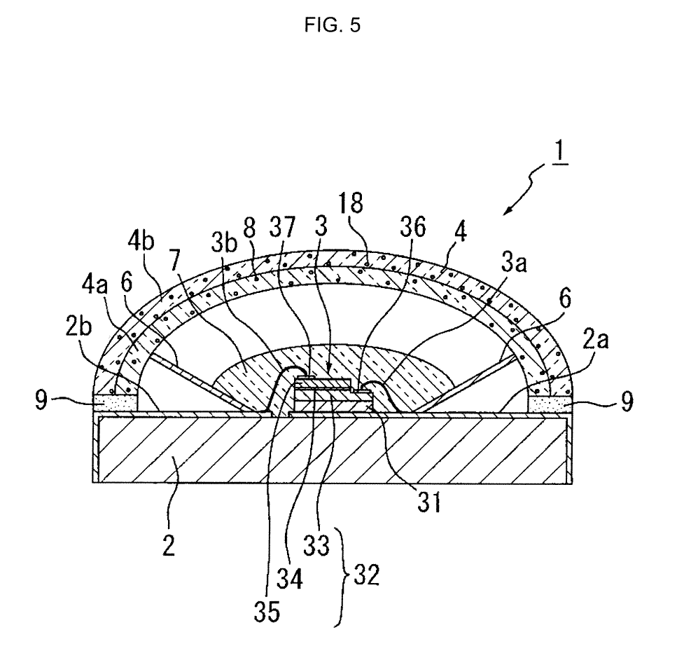

In addition, it is also acceptable for the fluorescent lens 4 to have, for example, a double-layered structure comprised of a fluorescent layer 4a on the inside and a diffusion layer 4b on the outside as shown in FIG. 5. The phosphor 8 is dispersed in the fluorescent layer 4a on the inside, while a diffusion material 18 is dispersed in the diffusion layer 4b on the outside. Furthermore, the fluorescent lens 4 could also be glass to which predetermined elemental ions have been added, whereby the ions would emit light upon being struck by excitation light from the light-emitting body 3.

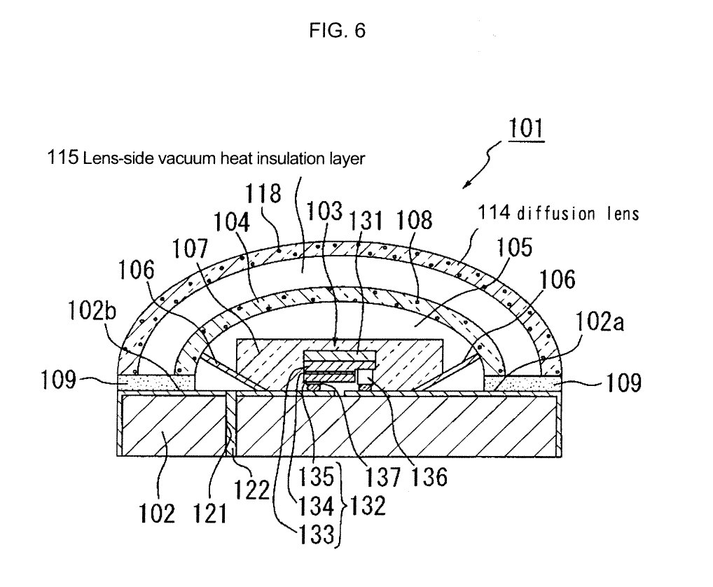

FIG. 6 is a schematic vertical sectional view showing a light-emitting device according to a second embodiment of the present invention. As shown in FIG. 6, a light-emitting device 101 includes an external substrate 102 as a plate-like heat dissipation member, a light-emitting body 103 mounted on the external substrate 102, which emits linear light, a fluorescent lens 104 covering the light-emitting body 103 on the external substrate 102, and a light-emitting-body-side vacuum heat insulation layer 105 formed between the fluorescent lens 104 and the light-emitting body 103. The light-emitting device 101 also includes a diffusion lens 114 covering the outside of the fluorescent lens 104, and diffusing light passing through the fluorescent lens 104 and, the lens-side vacuum heat insulation layer 115 formed between the diffusion lens 114 and the fluorescent lens 104. In addition, the light-emitting body 103 has a growth substrate 131, and a semiconductor laminate 132 formed on the growth substrate 131 by epitaxial growth. The light-emitting device 101 also includes a light reflector plate 106 on the external substrate 102, which reflects the light emitted by the light-emitting body 103 in a predetermined direction.

The external substrate 102 is made of a ceramic such as AIN and, in a planar view, is formed in a rectangular shape extending in a predetermined direction. In the external substrate 102, there is formed a communication hole 121, which communicates the outside of the device with the light-emitting-body-side vacuum heat insulation layer 105, and the communication hole 121 is blocked by a blocking member 122.

The light-emitting body 103 extends in the same direction as the external substrate 102 in a planar view, and emits light linearly on the external substrate 102 of a rectangular shape. The semiconductor laminate 132 has an n-type semiconductor layer 133, a light-emitting layer 134, and a p-type semiconductor layer 135, respectively from the side of growth substrate 131, in addition, an n-side electrode 136 and a p-side electrode 137 are formed on the n-type semiconductor layer 133 and the p-type semiconductor layer 135 respectively. Further, the light-emitting body 103 can be formed not only in a linear shape, but also in a planar shape extending along two directions of the longitudinal and lateral directions of the external substrate 102. In the embodiment, the light-emitting body 103 is a flip-chip type. In addition, the light-emitting body 103 emits blue light of which peak wavelength is, for example, 460 nm. The light-emitting body 103 is sealed with a transparent resin 107.

In addition, the light-emitting body 103 is mounted on the center part in the width direction of the external substrate 2. Furthermore, the light-emitting body 103 is formed of one LED element extending in the same direction as the extension direction of the external substrate 102. Namely, the light-emitting device 101 is entirely different in morphology from the LED print head in which the light-emitting body is mounted on the end parts in the width direction of the external substrate, and which is formed of a plurality of elements.

The fluorescent lens 104 is made of a transparent material such as glass, and contains a phosphor 108. When the phosphor 108 is excited by the light emitted from the light-emitting body 103, it emits a light with a different wavelength from that of the light. In the embodiment, the light-emitting body 103 is a yellow phosphor which emits a yellow light when excited by a blue light. Further, the fluorescent lens 104 could also be glass to which predetermined elemental ions have been added, whereby the glass itself would emit fluorescence. For example, by adding trivalent praseodymium ions to glass, a blue light, a green light and a red light are emitted from the praseodymium ions as luminescence centers when excited by the blue light.

The diffusion lens 114 is, for example, made of a transparent material such as glass, and contains a diffusion material 118. In the embodiment, the diffusion material 118 is, for example, ceramic particles such as TiO₂ and SiO₂. Further, the diffusion lens 114 may have a diffusion layer on its surface instead of containing the diffusion material 118. It is also possible to form the diffusion lens 114 from a transparent material other than glass, such as fiber-reinforced plastics (FRP).

In addition, the diffusion lens 114 is structured not to transmit ultraviolet light, so that it can block external ultraviolet light from penetrating. Here, ultraviolet light means a light with a wavelength of not more than 400 nm. Examples of structures which prevent transmission of ultraviolet light include those using ultraviolet blocking materials as the transparent material of the diffusion lens 114, and those having an ultraviolet-blocking diffusion layer installed on the surface of the diffusion lens 114. Examples of the ultraviolet blocking materials include a UV cut glass and a UV cut resin. An example of the diffusion layer opaque to ultraviolet light includes an ultraviolet-absorbing film.

In addition, diffusion lens 114 is installed via a heat-insulating material 109 disposed on the outer edge of the upper surface of the external substrate 102. In addition, the fluorescent lens 104 is also installed via the heat-insulating material 109. The heat insulating material 109 is formed so as to enclose the inner side of external substrate 102 in a planar view. By welding the diffusion lens 114 to the heat insulating material 109, it is possible to keep the diffusion lens 114 airtight. While the material of the heat insulating material 109 is optional, it is possible to use, for example, phenol resin, epoxy resin, melamine resin or silicone resin. The diffusion lens 114 has a semi-elliptical shape in section which extends in the same direction as the extension direction of the external substrate 102, and is formed to substantially align with the external substrate 102 in a planar view.

In addition, the fluorescent lens 104 is installed on the inner side of the diffusion lens 114, and has a similar sectional shape to that of the diffusion lens 114. The fluorescent lens 104 is formed shorter than the diffusion lens 114, and the interior and exterior of the fluorescent lens 104 are communicated with each other at both ends in the extension direction.

The light-emitting-body-side vacuum heat insulation layer 105 and the lens-side vacuum heat insulation layer 115 are formed by decompressing a gas, such as air, below atmospheric pressure. In the embodiment, the light-emitting-body-side vacuum heat insulation layer 105 and the lens-side vacuum heat insulation layer 115 are communicated with each other at both ends of the fluorescent lens 104, so that they have the same internal pressure. The internal pressure is preferably not more than 15 Torr, more preferably not more than 1.0 Torr, and even more preferably not more than 0.1 Torr. It is also possible to make the internal pressure not more than 10-5 Torr, or not more than 10-9 Torr.

The light reflector plate 106 is made of a heat insulating material, and is disposed in a pair on both sides in the width direction of the light-emitting body 103. The material of the light reflector plate 106 is optional, but it is possible to use, for example, phenol resin, epoxy resin, melamine resin or silicone resin. As shown in FIG. 2, the light reflector plate 106 divides the space between the external substrate 102 and the fluorescent lens 104, and the space between external substrate 102 and diffusion lens 114. On the surface of the light reflector plate 106, a thin metallic film such as an aluminum film with relatively high reflectivity is preferably formed.

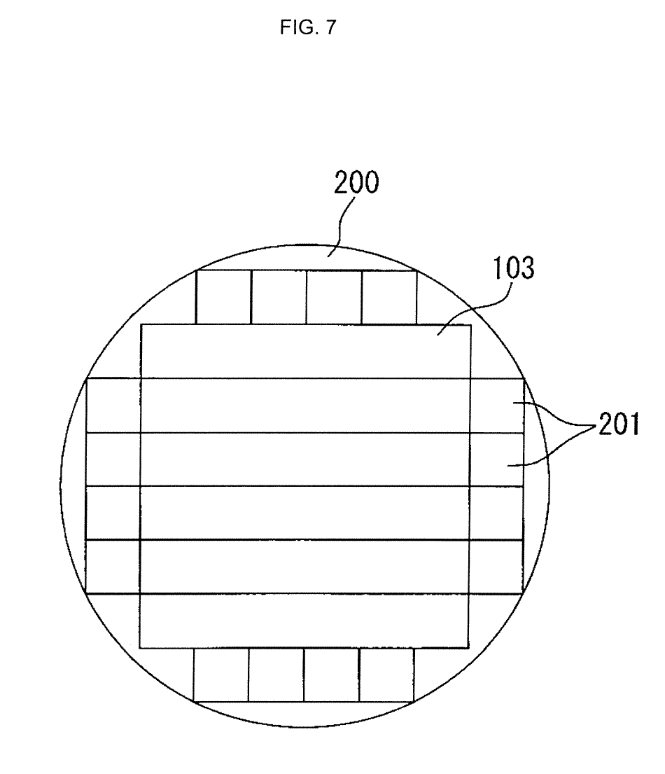

The light-emitting device 1 configured as described above is manufactured as follows. FIG. 7 is a plan view schematically showing a semiconductor wafer.

As shown in FIG. 7, the light-emitting body 103 is fabricated by cutting a disk-shaped semiconductor wafer 200 formed by a semiconductor laminate 32 on the growth substrate 31. In the center area of the semiconductor wafer 200, a plurality of long light-emitting bodies 103 are formed in the width direction adjacent to each other. And, at each outer end of each light-emitting body 103 on the semiconductor wafer 200, a substantially square-shaped light-emitting body 201 used in a point light source LED is formed.

In addition, the external substrate 102 is prepared separately to the light-emitting body 103, and the light reflector plate 106 is installed on the external substrate 102. The light-emitting body 103 is subsequently flip-chip mounted on the external substrate 102 and sealed with the sealing resin 107. In the embodiment, the sealing resin 107 is formed by bonding the resin tape covering the light-emitting body 103 to the upper surface of the external substrate 102. This facilitates the process of sealing the light-emitting body 103.

Next, the heat insulating material 109 to which the fluorescent lens 104 and the diffusion lens 114 are welded, is disposed on the external substrate 102. At this point, it is preferable for the heat insulating material 109 and the external substrate 102 to be joined by welding also.

Then, after discharging the air via a discharge port 121 on the external substrate 102 so as to create a vacuum in the light-emitting-body-side vacuum heat insulation layer 105 and the lens-side vacuum heat insulation layer 115, the discharge port 121 is blocked using a blocking member 122.

According to the light-emitting device 101 configured as stated above, when the light-emitting body 103 is energized via the first conductor 102a and the second conductor 102b of the external substrate 102, blue light is caused to be emitted from the light-emitting body 103, and this blue light then directly or indirectly enters the fluorescent lens 104. Part of the blue light which enters the fluorescent lens 104 is converted to yellow light by the phosphor 108, and a mixture light of blue light and yellow light is then radiated from the fluorescent lens 104 to the side of the diffusion lens 114. The mixed light radiated to the side of the diffusion lens 114 is diffused by the diffusion lens 114 then optically controlled by the surface of diffusion lens 114 and radiated in a desired direction. This is how white light is radiated from the light-emitting device 101.

In addition, according to the light-emitting device 101, the semiconductor laminate 132 extends in a predetermined direction, so that a relatively large current can be passed through the semiconductor laminate 132, which can in turn cause light to be emitted from the linear light-emitting body 103 at an arbitrary luminance. In addition, the semiconductor laminate 132 extends in a predetermined direction, so that the light emission area can be relatively increased, and the light emission state that is can be realized along the extension direction of semiconductor laminate 132. Furthermore, the external substrate 102 extends in the same direction as the extension direction of the light-emitting body 103, so that the dissipation area of the external substrate 102 can be increased, and heat transmission that is approximately uniform can be realized along the extension direction of the external substrate 102, and further heat dissipation performance of the device can be improved.

Most of the heat generated in semiconductor laminate 132 is transmitted to the side of external substrate 102, and this heat is hardly transmitted to the side of the fluorescent lens 104 due to heat insulation by the light-emitting-body-side vacuum heat insulation layer 105, so that deterioration of the fluorescent lens 104 can be inhibited. Furthermore, the heat generated in the semiconductor laminate 132 is hardly transmitted to the side of the fluorescent lens 104, so that deterioration of the phosphor 108 contained in the fluorescent lens 104 can be inhibited and the color of light emitted by the device can be inhibited from changing over time. It is therefore possible to exploit the inherently long life of the LED in the light-emitting body 103 without having to consider the deterioration of the phosphor 108.

In addition, according to the light-emitting device 101 of the embodiment, the diffusion lens 114 diffuses the light which passes through the fluorescent lens 104, so that the light emission state can be further homogenized. Also, the light-emitting-body-side vacuum heat insulation layer 115 is formed, so that heat applied to the diffusion lens 114 from the outside of the device is hardly transmitted to the fluorescent lens 104, and deterioration of the phosphor 108 of the fluorescent lens 104 due to heat generation factor at the outside of the device can be inhibited. Furthermore, external ultraviolet light does not pass through the diffusion lens so as to penetrate the fluorescent lens, so that deterioration of the fluorescent lens due to ultraviolet light can be inhibited. Accordingly, even if the light-emitting device 101 is used outdoors, the fluorescent lens 104 is not deteriorated by the ultraviolet light contained in sunlight.

According to the light-emitting device 101 of the embodiment, the diffusion lens 114 is installed on the external substrate 102 via the heat insulating material 109, so that the heat generated in the semiconductor laminate 132 is hardly transmitted to the side of diffusion lens 114, and deterioration of the diffusion lens 114 can be inhibited. In addition, heat is not transmitted from the mounting portion of the light-emitting body 103 towards the diffusion lens 114, when the light-emitting body 103 is used as a lighting fixture for illuminating indoor spaces or objects to be illuminated, the illuminated indoor space or object is not heated or thermally influenced by the light-emitting device 101.

Furthermore, the diffusion lens 114 and the heat insulating material 109 are welded, so that they can be joined together without interstices, and in case that the inside of the diffusion lens 114 is vacuated, airtightness thereof can be adequately ensured.

In addition, according to the light-emitting device 101 of the embodiment, the fluorescent lens 104 and the diffusion lens 114 are made of glass, so that their resistance to heat, weather and the like can be enhanced compared to lenses made from resin.

According to the light-emitting device 101 of the embodiment, heat generated from the light-emitting body 103 is transmitted from the center side to the both end sides in the width direction of the external substrate 102. Due to this, the heat generation can be efficiently dissipated in comparison with a case that the light-emitting body 103 is mounted on the end parts in the width direction of the external substrate 102. Furthermore, according to the light-emitting device 101, the light-emitting body 103 is formed of one element, so that variation in luminance, chromaticity and the like in the element is not visually recognized different from a case that the light-emitting body 103 is formed of a plurality of elements adjacent to each other.

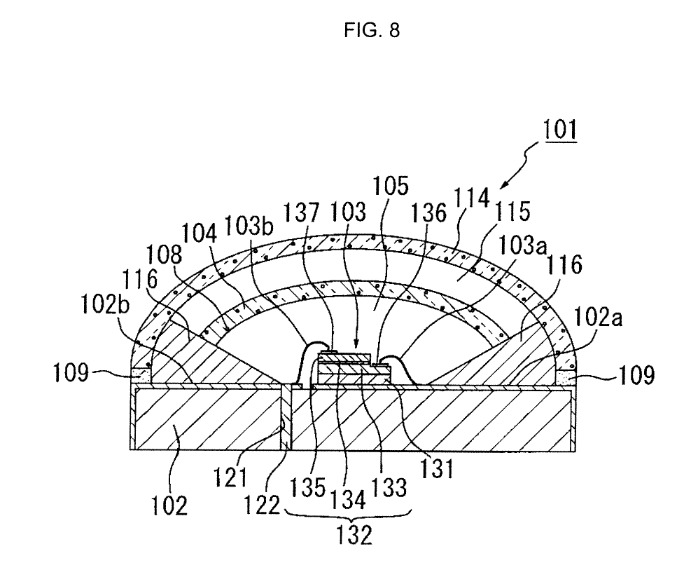

Further, in the second embodiment, the light-emitting body 103 sealed with the sealing resin 107 is shown, but, as shown in FIG. 8, for example, it is also possible for the sealing material such as the sealing resin 107 to be omitted, and for the light-emitting body 103 to adopt an unsealed structure. This prevents the light radiated from the light-emitting device 101 from changing over time as a result of deterioration of the sealing material. In addition, the process of the sealing light-emitting body 103 can also omitted when manufacturing the device, so that the manufacturing costs can be reduced.

In the light-emitting device 101 shown in FIG. 8, the light-emitting body 103 is a face-up type bonded to the external substrate 102 with a double-sided tape (not shown), and electrically connected to the first electrode 102a and the second electrode 102b via the first wire 103a and the second wire 103b. Even if the sealing resin 107 is omitted as described above, the light-emitting body 103 is hermetically sealed by the diffusion lens 114, the external substrate 102 and the like, so that it can prevent the wires 103a and 103b from being disconnected due to application of a load, and dust and the like from adhering to the light-emitting body 103. Furthermore, the inside of the device is kept in the vacuum state, so that it can prevent the light-emitting body 103 and the wires 103a, 103b from chemically reacting with atmospheric gases.

In the light-emitting device 101 shown in FIG. 8, the reflector member 116 formed of a heat insulating material with a reflective surface, is installed on the external substrate 102. Here, it is also possible for the reflector member 116 to be integrally formed with the external substrate 102. In this case, it is preferable that a heat insulating material is installed in the whole surface of the contact portion between the reflector member 116 and the fluorescent lens 104 and diffusion lens 114.

The diffusion lens 114 described in the second embodiment does not transmit ultraviolet light, but it is also possible to prevent external ultraviolet light from penetrating, for example, by forming an ultraviolet reflective film on the surface.

In addition, the light-emitting body 103 may emit ultraviolet light, and the fluorescent lens 104 may contain blue, green and red phosphor excited by the ultraviolet light. In this case, the diffusion lens 114 is configured so as not to transmit ultraviolet light, so that it can prevent ultraviolet light from being discharged externally from the light-emitting body 103.

The light-emitting body 103 described in the second embodiment is formed of one element, but even if the light-emitting body 103 is formed of any configuration such as being formed of a plurality of elements, if the light-emitting device 101 includes the light-emitting-body-side vacuum heat insulation layer 105 and the lens-side vacuum heat insulation layer 115, it is naturally expected that thermal insulating effect due to these layers can be obtained.

Although the typical embodiments of the present invention have been explained above, the present invention is not necessarily limited to the structures of these embodiments, and it is certainly possible to arbitrarily modify the specific detailed structure and the like.

### INDUSTRIAL APPLICABILITY

The light-emitting device of the present invention can be used as an alternative to a lighting fixture such as an incandescent lamp, a mercury lamp, a fluorescent lamp and the like. Namely, the light-emitting device of the present invention is different in the technical field from the LED print head that is not used for illumination, and simultaneously does not share common actions and functions with the LED print head.

1. A light-emitting device comprising:
a plate-like heat dissipation member;
a light-emitting body emitting linear or planar light, which is mounted on the heat dissipation member, and which has a substrate, and a semiconductor laminate extending in a predetermined direction and including a first conductivity-type first semiconductor layer, a light-emitting layer, and a second conductivity-type second semiconductor layer;
a fluorescent lens covering the light-emitting body on the heat dissipation member, which emits light with a different wavelength from the light of the light-emitting body when excited by the light;
a light-emitting-body-side vacuum heat insulation layer formed between the fluorescent lens and the light-emitting body;
a diffusion lens covering the outside of fluorescent lens, which diffuses light passing through the fluorescent lens; and
a lens-side vacuum heat insulation layer formed between the diffusion lens and the fluorescent lens;
wherein the heat dissipation member extends in the same direction as the extending direction of the light-emitting body.

2. The light-emitting device according to claim 1, wherein the diffusion lens inhibits external ultraviolet light from penetrating.

3. The light-emitting device according to claim 1, wherein the light-emitting device further comprises a heat insulating material that is provided on the outer edge side of the heat dissipation member's upper surface, and the diffusion lens is disposed on the heat dissipation member via the heat insulating material.

4. The light-emitting device according to claim 3, wherein the diffusion lens is welded on the heat insulating material.

5. The light-emitting device according to claim 4, wherein the fluorescent lens is disposed on the heat dissipation member via the heat insulating material.

6. The light-emitting device according to claim 3, wherein the fluorescent lens and the diffusion lens are made of glass.

7. The light-emitting device according to claim 4, wherein the fluorescent lens and diffusion lens are made of glass.

8. The light-emitting device according to claim 5, wherein the fluorescent lens and diffusion lens are made of glass.

9. The light-emitting device according to claim 2, wherein the light-emitting device further comprises a heat insulating material that is provided on the outer edge side of the heat dissipation member's upper surface, and the diffusion lens is disposed on the heat dissipation member via the heat insulating material.
